(19) United States
(12) Patent Application Publication
(10) Pub. No.: US 2008/0130854 A1
(43) Pub. Date: Jun. 5, 2008

(54) METHOD AND SYSTEM FOR PROVIDING GUARDIAN SERVICE BY USING CALLER ID

(75) Inventor: Byung-Wook Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., LTD, Suwon-si (KR)

(21) Appl. No.: 11/946,546

(22) Filed: Nov. 28, 2007

(30) Foreign Application Priority Data
Nov. 28, 2006 (KR) 2006-118501

(51) Int. Cl. H04M 1/56

(52) U.S. Cl. 379/142.05

(57) ABSTRACT

Disclosed are a method and a system for providing a service, by which a guardian can recognize the current state of a ward. To this end, the guardian must acquire a connection authority prior to recognizing the state of the ward. The acquisition of the connection authority is performed under the control of the server performing the authorization process. When a terminal of the guardian having the acquired connection authority tries to establish a remote connection, a terminal of a ward permits the connection after determining if the terminal having the right connection authority tries to establish a connection. When the connection is permitted, only a microphone is turned on, so that the terminal of the ward can transfer surrounding sounds to a terminal of the guardian. Therefore, the guardian can hear surrounding sounds, thereby recognizing the current sate of the ward, where the ward is and what the ward is doing.

### PRIORITY

This application claims priority under 35 U.S.C. §119(a) to an application entitled “Method and System for Providing Guardian Service by Using Caller ID” filed in the Korean Industrial Property Office on Nov. 28, 2006 and assigned Serial No. 2006-118501, the contents of which are incorporated herein by reference.

### BACKGROUND OF THE INVENTION

1. Field of the Invention

The present invention relates to a method and a system for providing a service, by which the state of a counterpart can be reported, and in particular, to a method and a system for providing a service, by which the state of a counterpart can be recognized under any circumstance.

2. Description of the Related Art

The recent phenomenon of rapid urbanization has resulted in widespread overpopulation and zealous materialism in societies, so that increasing crime rate has become a prominent social problem. In particular, abduction or kidnappings often occur so that, passengers using public transportation, such as taxis, at night may feel insecure.

Various application services have been developed to cope with these cases, such as a location based service, SOS service, etc.

By the location based service, a terminal of a ward provides location information of the ward to a terminal of a guardian through GPS receivers mounted in their terminals, so that the guardian can recognize the location of the ward. However, the location based service simply provides the location of the ward. This means that, even though parents having adolescent children want to know the current state of the children, that is, where the children are and what the children are doing, the parents can recognize only where the children are.

In addition, the SOS service allows a ward facing urgent circumstances to transmit short messages to a pre-determined receiving side in person, so that the urgent circumstances can be reported. However, the SOS service requires that a ward directly report the urgent circumstances, so it may be difficult for the ward (e.g. a faint woman, a child) to use the service.

### SUMMARY OF THE INVENTION

As described above, with the conventional location based service a guardian can only recognize the current location of a ward and the guardian cannot recognize the current state of the ward.

In addition, a conventional SOS service requires that a user facing urgent circumstances personally report the accident by using a mobile communication terminal. However, it may be impossible for a user facing urgent circumstances (e.g. building collapse, a landslide, abduction) to report the accident.

Accordingly, the present invention solves the above-mentioned problems occurring in the prior art, and the present invention provides a method and a system for providing a service, by which a guardian can recognize the current state of a ward.

Also, the present invention provides a method and a system for providing a service, which enables a guardian to recognize the state of a ward facing urgent circumstances without direct input from the ward.

In accordance with an aspect of the present invention, there is provided a system for providing a guardian service by using a caller D, the system includes one or more call-terminating terminals; a call-originating terminal for acquiring a connection authority regarding said one or more call-terminating terminals, and establishing a communication connection with the call-terminating terminal based on the acquired connection authority when a user makes a request for a guardian service with the selected call-terminating terminal; and an authority server for authenticating the call-originating terminal and providing a connection authority to the authenticated call-originating terminal, upon receiving a request for a connection authority from the call-originating terminal, wherein the call-terminating terminal commands a speaker to turn off and performs communication after determining if a connection of the call-originating terminal is permitted, when the call-originating terminal makes a request for a guardian service.

In accordance with another aspect of the present invention, there is provided a method for providing a guardian service by using a caller ID, the method includes making, by a call-originating terminal, a request for a connection authority of one or more call-terminating terminals; providing, by an authority server, the connection authority in response to a request for the connection authority after authenticating the call-originating terminal; making, by the call-originating terminal, a request for a communication connection with the call-terminating terminal based on the connection authority regarding the selected call-terminating terminal when a user inputs a request for a guardian service of the selected call-terminating terminal; and performing, by the call-terminating terminal, communication while a speaker is turned off after determining if a connection of the call-originating terminal is permitted in response to the request for the communication connection.

### BRIEF DESCRIPTION OF THE DRAWINGS

The above and other aspects, features and advantages of the present invention will be more apparent from the following detailed description taken in conjunction with the accompanying drawings, in which:

FIG. 1 is a system overview of the construction of a mobile communication system for providing a guardian service according to the present invention;

FIG. 2 is a ladder diagram illustrating a procedure of acquiring a connection authority according to the present invention;

FIG. 3 is a ladder diagram illustrating a procedure of providing a guardian service in a mobile communication system according to the present invention; and

FIG. 4 shows the structure of Caller ID (CID) information according to the present invention.

### DETAILED DESCRIPTION OF THE PREFERRED EMBODIMENT

An exemplary embodiment of the present invention will be described with reference to the accompanying drawings. In the following description, a detailed description of known functions and configurations incorporated herein will be omitted when it may make the subject matter of the present invention rather unclear.

The present invention implements a function of providing a service, which enables a guardian to recognize the current state of a ward. To this end, the guardian must first acquire a connection authority prior to recognizing the state of the ward. The acquisition of this connection authority is performed under the control of a server, which performs authorization. When a terminal of the guardian tries to establish a remote connection by using the acquired connection authority, the terminal of the ward permits the connection after determining if the terminal trying to establish a connection has the right connection authority. When the connection is permitted, only a microphone is turned on while a speaker is turned off in the terminal of the ward, so that the terminal of the ward can transfer surrounding sounds to the terminal of the guardian. Therefore, the guardian can hear the surrounding sounds, thereby recognizing the current state of the ward, that is, where the ward is and what the ward is doing.

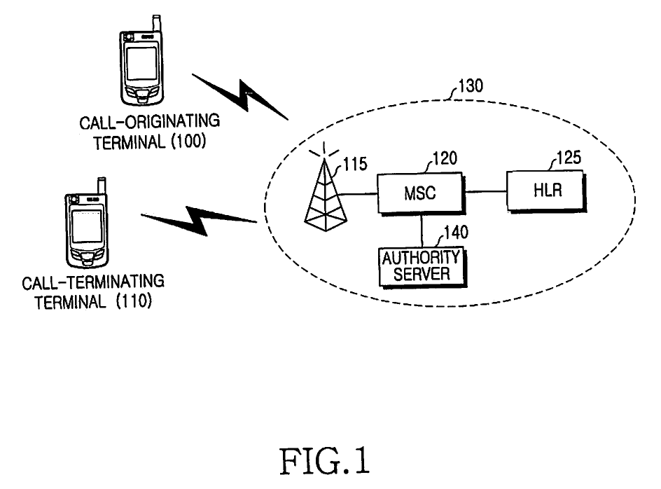

Referring to FIG. 1, the mobile communication system, to which the present invention is applied, performs a call connection by establishing wireless communication with mobile communication terminals. As used herein, the mobile communication terminals are classified into a call-originating terminal for a guardian 100, which originates a call in order to establish a remote connection, and a call-terminating terminal for a ward 110, which terminates the call in response to the originating call. FIG. 1 is a block diagram illustrating the constructions of the mobile communication system for providing a guardian service according to an embodiment of the present invention.

The mobile communication system includes call-originating terminal 100, call-terminating terminal 110, a BS (Base Transceiver Station/Base Station Controller) 115, an MSC (Mobile Switching Center) 120, a HLR (Home Location Register) 125, a mobile communication network 130, and an authority server 140.

First, BS 115 is wirelessly connected with respective terminals 100 and 110, and it communicates with terminals 100 and 110 over the air interface, controls a wireless link and a wired link, and performs handoff enabling a user on the move to maintain continuous communication. MSC 120 interworks with other MSCs so as to deal with originating/terminating calls requested from respective terminals 100 and 110, and researches users of terminals by HLR 125. The HLR 125 is a middle-sized computer mainly for managing users of terminals, it stores information concerning users and locations of terminal and can designate a path in relation to a terminating call.

In particular, authority server 140 manages authorization, and grants an ID (identity) of connection permission to call-originating terminal 100, a terminal of a guardian which requests a guardian service, thereby authenticating call-originating terminal 100. Also, authority server 140 commonly provides the ID to call-terminating terminal 110, a terminal of a ward, in order to perform mutual authentication with call-originating terminal 100.

In the following description, a network including BS 115, MSC 120, HLR 125, and authority server 140, which provide mobile communication services to mobile communication terminals, is defined as core network 130. In the present invention, a network for providing a guardian service to a mobile communication terminal for a guardian is referred to as core network 130.

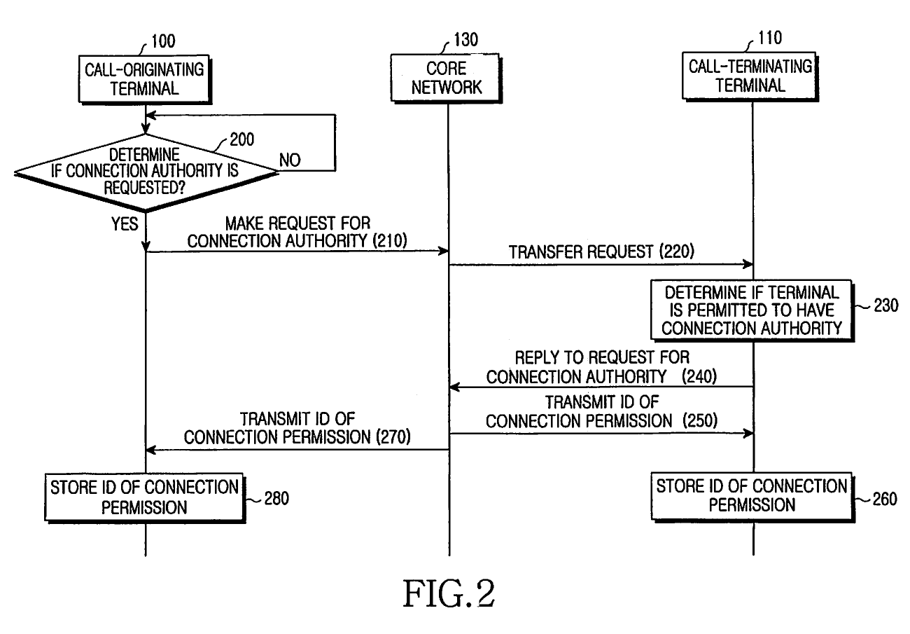

In the mobile communication system, which has the same construction as, that described above and provides a guardian service, operations between respective components will be described. The procedure of acquiring the connection authority will be described with reference to FIG. 2. In order to provide a guardian service, after a microphone alone is turned on in the terminal of the ward, a predefined connection authority is required for transmitting received sound information to a terminal of the guardian through core network 130. Under the control of authority server 140 of core network 130, authentication for a remote connection is performed between call-originating terminal 100 and call-terminating terminal 110 according to an embodiment of the present invention. In addition, messages transmitted and received from/at respective terminals 100 and 110 are transferred through the base stations, etc. For convenience, the network for performing the operations as described above is referred to as a “core network 130.”

In order to acquire the connection authority, in step 200, call-originating terminal 100 determines if a user inputs a request for a connection authority to establish a remote connection. When it is determined that the user inputs a request for a connection authority, call-originating terminal 100 transmits a request to core network 130 so as to acquire a connection authority in step 210. Then, core network 130 transfers the request to call-terminating terminal 110 in step 220.

Meanwhile, call-terminating terminal 110 receives the request for the acquisition of a connection authority, and it determines if the terminal requesting the connection authority is permitted to have the connection authority, in step 230. In step 240, the call-terminating terminal 110 transmits a reply containing a determination result in response to the request for the connection authority. For convenience, description is given with reference to FIG. 2, in which it is assumed that call-originating terminal 100 corresponds to a connection permitted terminal that can acquire a connection authority. It is also assumed that a reply, representing that the call-terminating terminal allows the call-originating terminal to acquire the connection authority, is transmitted in step 240. Then, core network 130 transmits an ID of connection permission necessary for authentication to both call-terminating terminal 110 and call-originating terminal 100, in steps 250 and 270, respectively. This means that core network 130 provides the common ID of connection permission to call-terminating terminal 110 and call-originating terminal 100.

In step 260, call-terminating terminal 110 stores the ID of connection permission transmitted from core network 130. In step 280, call-originating terminal 100 also stores the ID of connection permission transmitted from core network 130. In this case, call-originating terminal 100 may store the ID of connection permission obtained by mapping an ID of connection permission with the telephone number of call-terminating terminal 110, so that call-originating terminal 100 can try to establish a remote connection even when the ID of connection permission alone is selected. Applications necessary for mutual authentication are implemented in call-originating terminal 100 and call-terminating terminal 110. In this manner, call-originating terminal 100 can acquire an ID of connection permission in relation to at least one call-terminating terminal.

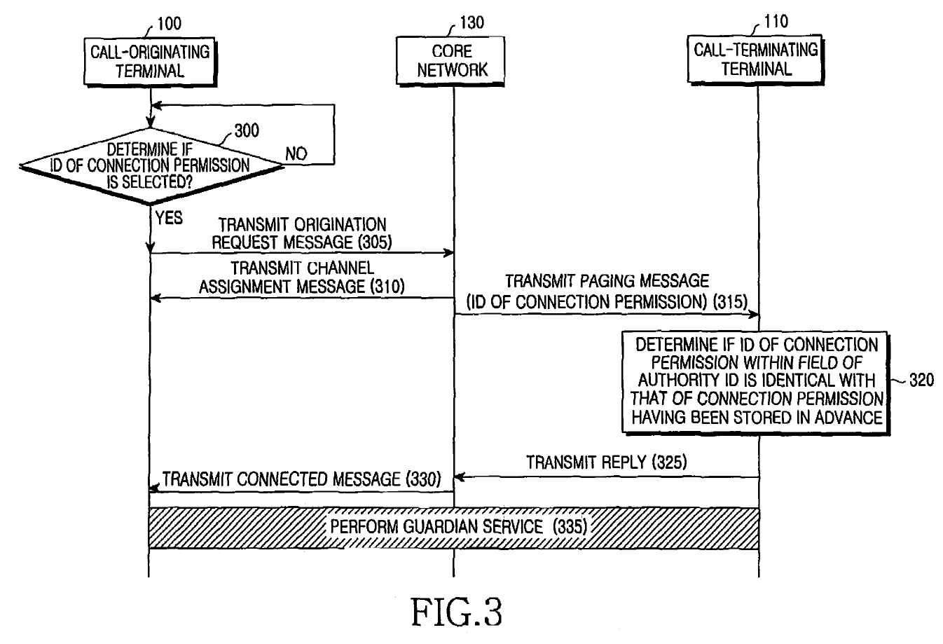

After acquiring the connection authority through the above-mentioned procedures, call-originating terminal 100 can try to establish a remote connection by using the acquired connection authority. The procedure of providing a guardian service through a remote connection is described with reference to FIG. 3. In order to provide a guardian service to call-originating terminal 100, call-terminating terminal 110 analyzes if the call-originating terminal requesting a guardian service through a remote connection has a right connection authority, and provides functions capable of initiating the guardian service. In the embodiment of the present invention, authority server 140 uses a caller ID service (CID) to establish a remote connection between call-originating terminal 100 and call-terminating terminal 110.

In general, the CID service allows the telephone number of a caller to be displayed on the recipient's display device, thereby enabling the recipient to recognize the telephone number of the caller. However, in the embodiment of the present invention, a code value, representing a request for a call connection according to a guardian service, is setup in CID information so that a call connection can be established without direct input from the recipient. Thereafter, when the CID information containing the code value is transmitted to call-terminating terminal 110, the call-terminating terminal does not terminate the call; rather it commands only a microphone to turn on transferring surrounding sounds to the call-originating terminal. That is, it is preferred that the call-terminating terminal does not output a ring tone of the termination call so that the recipient cannot recognize that the call is terminated, and the call-terminating terminal keeps the speaker turned off so that the caller's voice is not outputted from the call-originating terminal.

In order to provide the guardian service, in step 300, call-originating terminal 100 determines if a user selects the ID for connection permission. In this case in which call-originating terminal 100 provides a menu for a remote connection to a user, when the user selects the menu, the connection authority displays a list including all connection permission IDs having been acquired in advance. It is possible for the user to select any one of the connection permission IDs in the list.

When it is determined in step 300 that a connection permission ID is selected, call-originating terminal 100 transmits an origination request message containing the selected connection permission ID to core network 130 in step 305. That is, the caller can try to establish a call connection with a call-terminating terminal having a corresponding connection permission ID, without inputting the telephone number of the recipient. In this case, the connection permission ID is stored in relation to the telephone number of a recipient as soon as a connection authority is acquired. Alternatively, when a user selects a menu of the guardian service after inputting the telephone number of a recipient, the connection permission ID mapped to the telephone number of the recipient is searched for and the searched ID is inserted in an origination request message. Therefore, the resultant origination request message can be transmitted.

Meanwhile, after selecting a connection permission ID, for example, when the user presses a key for a communication connection, call-originating terminal 100 tries to establish a communication connection. After the key of the communication connection is inputted, in step 305, call-originating terminal 100 transmits an origination request message for call-terminating terminal 110 to core network 130, as shown in FIG. 3. As used herein, the origination request message means a request for initiation of a guardian service because it contains the ID of connection permission.

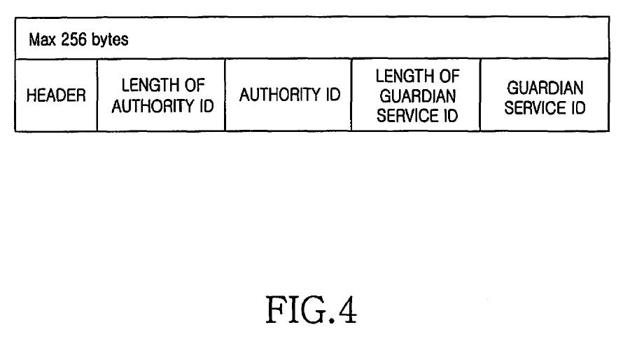

In step 310, core network 130 transmits a channel assignment message to call-originating terminal 100 so as to establish a channel. In step 315, core network 130 transmits a paging message to call-terminating terminal 110 so as to try to establish a call connection. In this case, the connection permission ID is converted into the format of the CID information and the converted CID information is transmitted to call-terminating terminal 110. The CID information is contained in the alert with information message and the resultant CID information is transmitted. The CID information is setup in a predetermined field of the alert with information message, which is to be transmitted to call-terminating terminal 110, and the resultant CID information is transmitted. The structure of the CID information is shown in FIG. 4.

Referring to FIG. 4, the CID information has a maximum size of 256 bytes, and consists of a header, the header representing the CID information, a length of an authority ID, an authority ID, a length of a guardian service ID, a guardian service ID. The field of the authority ID contains the connection permission ID, which is actually transmitted from call-originating terminal 100. In the field of the guardian service ID, a code value is setup to report a message for providing a guardian service, but not for enabling a recipient to recognize who a caller is.

Therefore, while a call connection is tried by transmission of the paging message, the alert with information containing the CID information is transmitted to call-terminating terminal 110. Then, call-terminating terminal 110 recognizes that the current call connection attempt is a request for a guardian service, based on the CID information within the alert message. That is, call-terminating terminal 110 analyzes the field of the guardian service ID within the CID information, thereby recognizing that the guardian service is requested.

In step 320, call-terminating terminal 110 analyzes the field of authority ID within the CID information, and determines if the connection permission ID within the field of the authority ID is identical with that of connection permission, which has been stored in advance. In response to the terminating call transmitted through the paging message, call-terminating terminal 110 transmits a reply containing a determination result to core network 130. When it is determined that the ID of connection permission within the field of the authority ID is identical with that of connection permission having been stored in advance, call-terminating terminal 110 transmits a reply, representing that a remote connection is permitted, to core network 130, in step 325.

When call-terminating terminal 110 replies to the terminating call transmitted through the paging message, core network 130 transmits a connected message (i.e. connection success) to call-originating terminal 100 in step 330. However, when it is determined that the connection permission ID within the field of the authority ID is not identical with that of connection permission within call-terminating terminal 110, call-terminating terminal 110 transmits a reply to core network 130, representing that a remote connection is denied. Then, core network 130 may transmit a connected failure message (i.e. connection failure) instead of a connected message. FIG. 4 exemplifies that core network 130 receiving the reply transmits the connected message, the reply representing that the remote connection is permitted.

As described above, when the connected message is transmitted to call-originating terminal 100, in step 335, a communication channel is established between call-originating terminal 100 and call-terminating terminal 110, and the guardian service is performed. Hence, call-terminating terminal 110 permits the remote connection and commands the microphone alone to turn on so as to provide the guardian service. Therefore, even when a recipient does not press a key for a communication connection, call-originating terminal 100 directly establishes a communication connection with call-terminating terminal 110 as if a general connection call is established, so that it can deliver all sounds inputted through the microphone of call-terminating terminal 110 to a caller.

When the above-mentioned guardian service is used, a guardian uses the connection authority having been acquired in advance to establish a remote connection with a terminal of a ward, so that the guardian can hear sounds delivered from the terminal, and easily recognize what the ward is doing and where the ward is.

As described above, the present invention provides an advantage in that, after acquiring the authority to be connected to a terminal of a ward, the terminal of a guardian having the acquired connection authority establishes a remote connection, so the guardian can hear surrounding sounds of the ward and recognize the current sate of the ward. Particularly, the present invention provides an advantage in that, even when a ward facing urgent circumstances (e.g. abduction, kidnapping, violence) does not perform a separate operation, a guardian can recognize the state of the ward by establishing a remote connection.

While the invention has been shown and described with reference to a certain exemplary embodiment thereof, it will be understood by those skilled in the art that various changes in form and details may be made therein without departing from the spirit and scope of the invention as further defined by the appended claims.

What is claimed is:

1. A system for providing a guardian service by using a caller ID (CID), the system comprising:
one or more call-terminating terminals;
one or more call-originating terminals for acquiring a connection authority regarding said one or more call-terminating terminals, and establishing a communication connection with a selected call-terminating terminal based on the acquired connection authority when a user makes a request for a guardian service with the selected call-terminating terminal; and
an authority server for authenticating the call-originating terminal and providing a connection authority to the authenticated call-originating terminal, upon receiving a request for a connection authority from the call-originating terminal,
wherein the call-terminating terminal commands the speaker to turn off when the call-originating terminal makes a request for a guardian service and performs communication after determining if a connection of the call-originating terminal is permitted.

2. The system as claimed in claim 1, wherein, upon receiving the request for the connection authority from the call-originating terminal, the authority server transfers the request for the connection authority to a corresponding call-terminating terminal and provides a connection authority ID to both the call-originating terminal and the corresponding call-terminating terminal in response to a reply from the corresponding call-terminating terminal.

3. The system as claimed in claim 2, wherein, upon receiving the request for the guardian service containing the connection authority ID from the call-originating terminal, the authority server makes the connection permission ID in a form of CID information within an alert with information message and transfers the resultant CID to the corresponding call-terminating terminal.

4. The system as claimed in claim 3, wherein the corresponding call-terminating terminal determines if the connection permission ID within the CID information received from the authority server is identical with that of connection permission having been stored in advance, so that the corresponding call-terminating terminal may determine if the connection of the call-originating terminal is permitted.

5. A method for providing a guardian service by using a caller ID (CID), the method comprising the steps of:
(a) making, by a call-originating terminal, a request for a connection authority of one or more call-terminating terminals;
(b) providing, by an authority server, the connection authority in response to a request for the connection authority after authenticating the call-originating terminal;
(c) making, by the call-originating terminal, a request for a communication connection with the call-terminating terminal based on the connection authority regarding a selected call-terminating terminal when a user inputs a request for a guardian service of the selected call-terminating terminal; and
(d) performing, by the call-terminating terminal, communication while a speaker is turned off after determining if a connection of the call-originating terminal is permitted in response to the request for the communication connection.

6. The method as claimed in claim 5, wherein step (b) further comprises:
transferring, by the authority server, the request for a connection authority to a corresponding call-terminating terminal, upon receiving the request for the connection authority from the call-originating terminal; and
providing connection permission ID to both the call-originating terminal and the corresponding call-terminating terminal in response to a reply from the corresponding call-terminating terminal.

7. The method as claimed in claim 5, wherein step (c) further comprises:
transmitting, by the call-originating terminal, a request for a guardian service to the authorization server, the request containing the connection permission ID; and
making, by the authority server, the connection permission ID in a form of CID information within an alert with information message in response to the request, and transferring the resultant CID information to the corresponding call-terminating terminal.

8. The method as claimed in claim 5, wherein, in determining if the connection is permitted in step (d), the call-terminating terminal determines if the identity of the connection permission contained in the CID information received from the authority server is identical with that of connection permission having been stored in advance.
